(19) United States
(12) Patent Application Publication
(10) Pub. No.: US 2014/0160162 A1
(43) Pub. Date: Jun. 12, 2014

(54) SURFACE PROJECTION DEVICE FOR AUGMENTED REALITY

(71) Applicants: Dhanushan Balachandreswaran, Richmond Hill (CA); Tharoonan Balachandreswaran, Richmond Hill (CA)

(72) Inventors: Dhanushan Balachandreswaran, Richmond Hill (CA); Tharoonan Balachandreswaran, Richmond Hill (CA)

(21) Appl. No.: 14/102,819

(22) Filed: Dec. 11, 2013

Related U.S. Application Data
(60) Provisional application No. 61/736,032, filed on Dec. 12, 2012.

(51) Int. Cl. G06T 19/00; G02B 27/01

(52) U.S. Cl. CPC G06T 19/006; G02B 27/017
USPC 345/633; 345/8

(57) ABSTRACT

Augmented reality (AR) is the process of overlaying or projecting computer generated images over a user's real world view of the physical world. The present invention allows for gameplay and/or training to contain augmented special effects. It is used to create surface patterns which are incorporated into augmented reality systems. It also allows for gesture control of AR elements during use.

### RELATED APPLICATIONS

This application claims the benefit under 35 U.S.C. 119(e) of U.S. Provisional Patent Application Ser. No. 61/736,032 filed Dec. 12, 2012, which is incorporated herein by reference in its entirety and made a part hereof.

### FIELD OF THE INVENTION

The present invention relates generally to the field of augmented reality technologies, and specifically to augmented reality board games, and real time strategy games.

### BACKGROUND OF THE INVENTION

Augmented reality (AR) is the process of overlaying or projecting computer generated images over a user's view of the real physical world. The present invention is a system for gameplay or training that contains augmented special effects to provide users with surreal gaming experiences. A surface projection device is used to create surface patterns to be recognized and incorporated into augmented reality systems primarily to be used with augmented reality goggles, visors or other visual systems to view AR effects. The surface projection device uses a camera system to capture physical interaction with the surface by relaying the coordinates and properties of the interaction to the AR visors. Similarly, human or non-human gestures can also be captured with the camera system and analyzed to provide gesture control properties for the AR environment.

Attempts at creating board games that create a more immersive experience have been attempted previously. For example, U.S. Pat. No. 5,853,327 describes a computerized board game which combines aspects of a board game and a computer game. A board serves as an apparatus for sensing the location of toy figures that are used in the game and then the board serves to actuate an audio/visual display sequence on the computer in response to their position. The described game does not contain any augmented or virtual reality elements and thus may not offer as immersive experience as the present invention.

U.S. Pat. No. 7,843,471 discloses a method and apparatus to map real world objects onto a virtual environment. This invention provides methods for scanning and using real life objects and using them in computer games. It does not contain any virtual and augmented reality sequences that directly engage users. U.S. Pat. No. 7,812,815 discloses an apparatus for providing haptic feedback in a virtual reality system and can be used for gaming. However, the device is quite large and stationary. It requires the user to remain stationary and be limited to using a display device such as a monitor for generating the necessary graphics.

The prior art provides a number of devices and systems that enhance or aid in creating an enhanced game experience. However, many lack portability, requiring the users to be stationary either at a computer or within a predefined area where the game takes place. In addition, aside from U.S. Pat. No. 8,292,733, the prior art is mostly limited to game displays on monitors and they do to allow fully immersive gameplay.

The present invention provides a device and system for fully immersive augmented and virtual reality gameplay on any type of surface. The present invention takes into account gestures and does not necessarily require controllers for interaction with virtual objects. The present invention is highly portable and can be used to play most types of games or to project any required type of augment or virtual objects that can be moved or manipulated in various of ways.

### BRIEF DESCRIPTION OF THE DRAWINGS

Embodiments herein will hereinafter be described in conjunction with the appended drawings provided to illustrate and not to limit the scope of the claims, wherein like designations denote like elements. The drawings are described as follows:

FIG. 1 shows conceptual sample block diagram of internal hardware of the Surface Projection Device (SPD);

FIG. 2 shows a conceptual drawing of a surface projection device being tailored for AR surfaces;

FIG. 3 shows the ability for an SPD to be mounted in any orientation. Regardless of the visor's position, it can interact with the visor via its compass;

FIG. 4 (a-b) show a user wearing an Augmented Reality (AR) visor mounted as a Heads Up Display (HUD) being used with the projection device;

FIG. 5 shows a detailed conceptual representation of the SPD and the AR visor capturing the infrared grid;

FIG. 6 shows the visor's imaging system while being worn by a user of the AR system;

FIG. 7 shows the process of acquiring the camera perspective and position using feature matching; and

FIG. 8 shows an example of a projected pattern that can be used to play a chess game.

### DETAILED DESCRIPTION OF THE PREFERRED EMBODIMENTS

A variety of new computer technologies and software are presently developed by researchers wishing to advance aspects of new augmented reality gaming software, hardware, and design. In the recent years, the making of augmented reality games and hardware has become more practical through the recent advances of technologies and reduction in microprocessor costs.

The present invention is best described as an augmented reality system which enables interactive augmented games, simulations and other media content to be displayed on a surface by using a projection device to create real time visible and or invisible surface patterns.

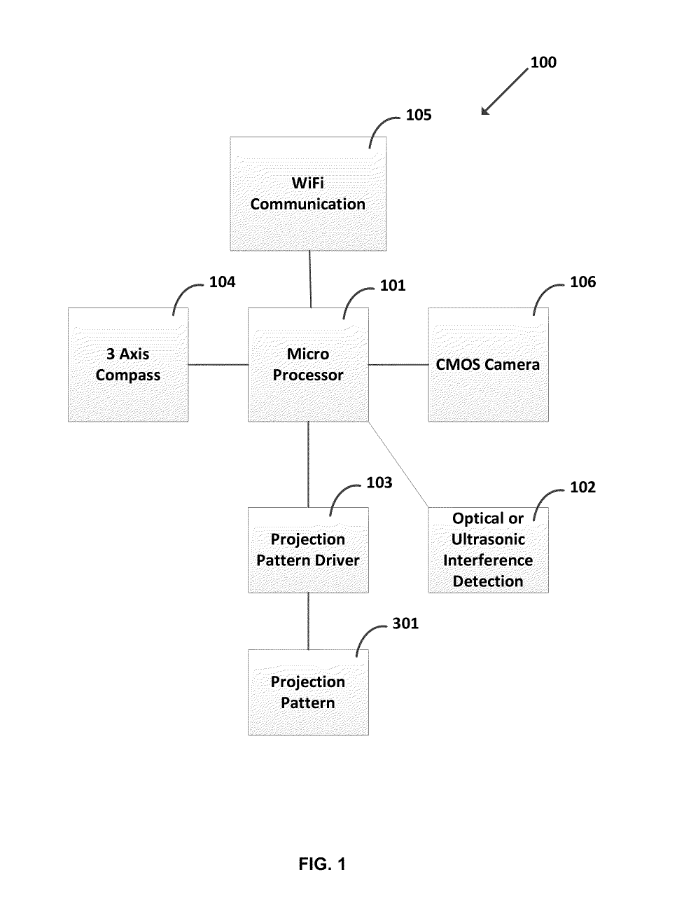

The surface projection device 100, having its components described in FIG. 1, can refer to any augmented reality system. The SPD 100 can be used to portray existing or imagined natural environments for military tactical planning, large cities and towns for city planning or disaster prevention, buildings for architectural planning, AR adaptations of real time strategy games and other similar scenarios. The SPD 100 allows for a high level of customizability and adaptability, allowing users to create their own scenario-specific environments that can be projected on any surface. This concept has frameworks and designs that cooperate with hardware and software components throughout the game.

The SPD 100 may be described as a portable device that constructs boundaries or objects for augmented reality surface games, simulations or architectural objects. As shown in FIG. 1, the surface projection device (SPD) 100 is comprised of a microprocessor 101, an optical or ultrasonic interference detector 102, a projection pattern driver 103, a 3-axis compass 104, a Wi-Fi communicator 105, and a CMOS camera 106. Additionally, in alternative embodiments the SPD 100 can have a built in full inertial measurement unit instead of or in addition to the digital compass 104 that can determine its orientation. The inertial measurement unit will allow the SPD 100 to detect and create correlating coordinate systems that will aid in the human or object interaction with virtual objects on the projected surface.

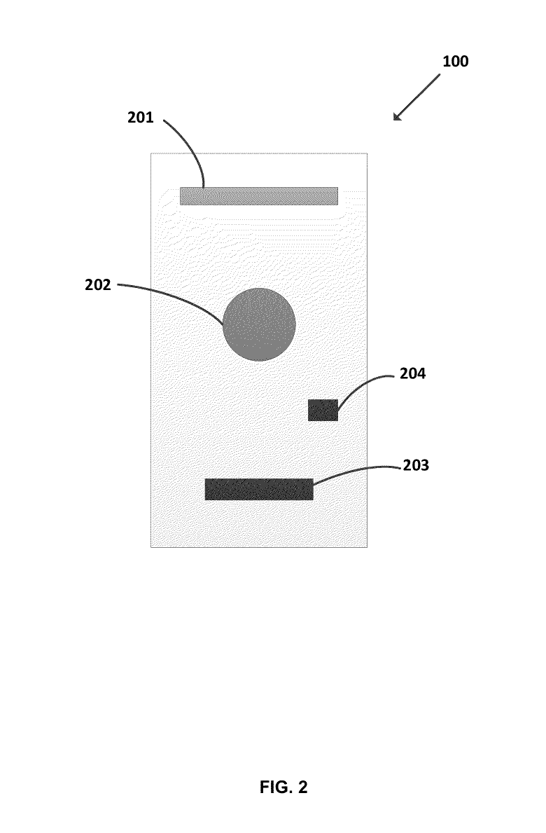

FIG. 1 and FIG. 2 show one embodiment of the SPD 100. The microprocessor 101 may be found in the micro computation unit 201 that is used to generate random or predefined patterns. The optical or ultrasonic interference detector 102 may use data provided by distance and orientation sensors 203 such as ultrasound sensor, laser range finders, gyroscopes etc. The projection pattern driver 103 serves to control the function of the projector sensor 202 that with combination of emitted light and lens would project the desired AR patterns to any surface. The Wi-Fi communicator 204 can also be substituted with a wired communication system in other embodiments, which provides Wi-Fi 105 and other communication capabilities for the SPD 100. The wired and wireless communication system 105 will be used for communication between the SPD 100 and the AR visors 300.

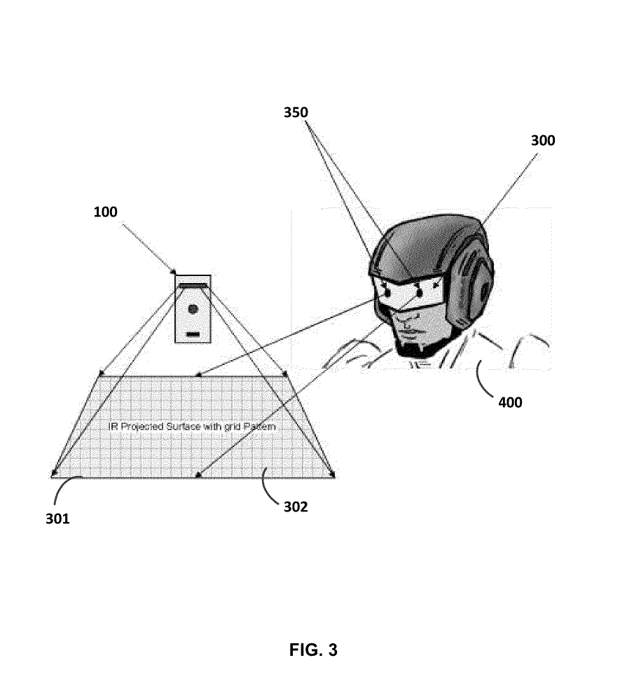

The AR visor 300 is shown in FIG. 3 and is used to detect the projected pattern 301 by the SPD 100. For detection and acquisition of the physical environment, the AR visor 300 contains one or more cameras which can scan and view the surface 302 in 3D. Additionally, the AR visor 300 has means to determine its direction, orientation and speed of said AR visor relative to the surface 302 and or the SPD 100. This information is relayed to the SPD 100 with the use of a Wi-Fi communicator on the AR visor 300. The AR Visor is capable of generating computer generated imagery and as such contains and a processor unit to process collected data from the camera and other sensor and to create graphics imagery objects. The AR visor 300 also contains a screen or other form of display in order to provide the AR and virtual contents to the user 400. A battery management and supply unit provides power to the AR Visor 300.

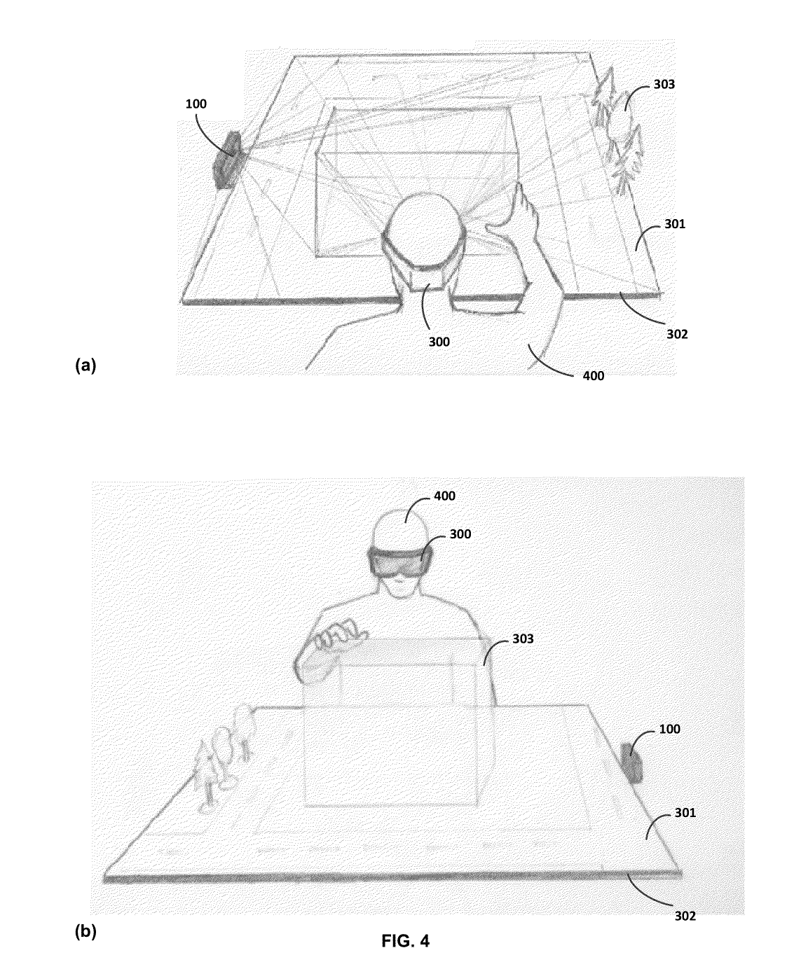

The SPD 100 projections consist of light patterns 301 that are projected within the boundaries of the grid onto a surface mat 302, as shown in FIG. 3 and FIG. 4. The SPD 100 is able to detect its orientation via its compass 104 and accordingly adjust the orientation and projection of the surface patterns 301. The projected light patterns 301 can be in any shape or size, abstract design or property depending on the projected boundaries. The SPD 100 enables users to interact with the surface projections 301 as well as the AR visor's 300 augmented world using their fingers and physical gestures. Computer Graphics Imagery (CGI) along with other techniques can be used by the SPD 100 to create images and objects 303 that coexist with elements created by the AR visor 300. The SPD 100 can project visible characteristics or surface characteristics such as rain, snow or sand by augmenting the CGI through the visor 300. Once these effects are displayed in the visor 300, the users can then control these surface or visible characteristics.

In FIG. 4, the SPD 100 creates dynamic surface patterns 301 that are recognized and incorporated into augmented reality systems, primarily the AR visors 300. The SPD 100 projects grids or other pattern-like systems 301 that the AR visor(s) 300 detects. The SPD 100 measures the size and pattern of the projected grid 301 and then uses this information to augment images and objects 303 overlaid on the projected grid 301. FIG. 4 shows that the SPD 100 provides and manipulates a surface space 302 that may or may not be physical, with a projected light source and pattern 301 that can be detected by AR visors 300 or other imaging systems that may exist. The projected light source acts as a projected grid 301, or as boundaries or any other game properties that are to be used as inputs for an Augmented Reality system. Through the AR visor 300, the projected grid 301 can be detected and used as input to develop the associated graphics and objects 303 that virtually overlay the surface of the projected pattern 301. The projected pattern can also move, orient or reposition itself and this behaviour can be detected with the AR visor 300. The projected grid or pattern can be made to be visible or invisible to the user depending on their preference or game settings.

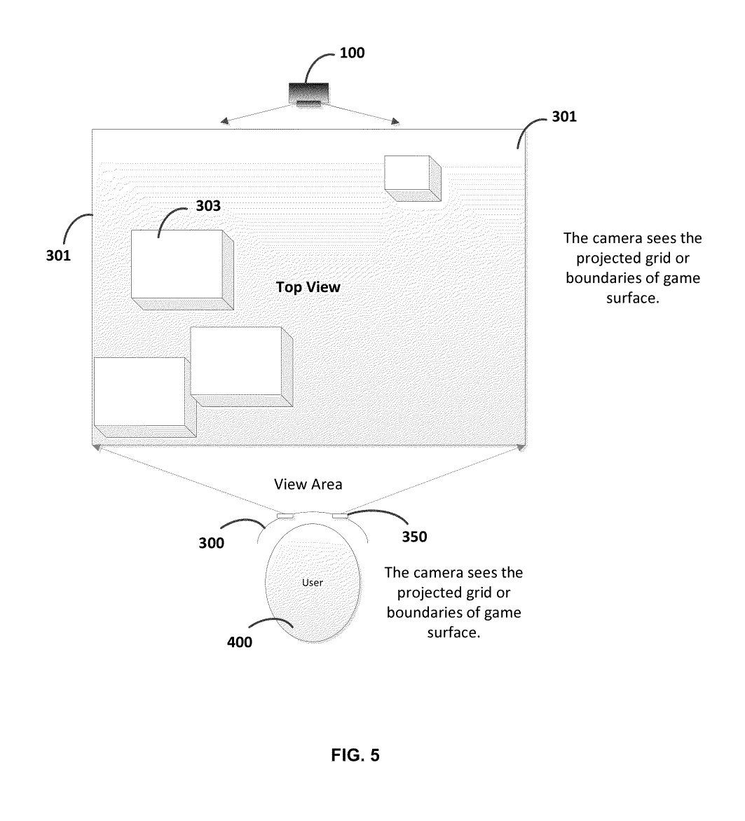

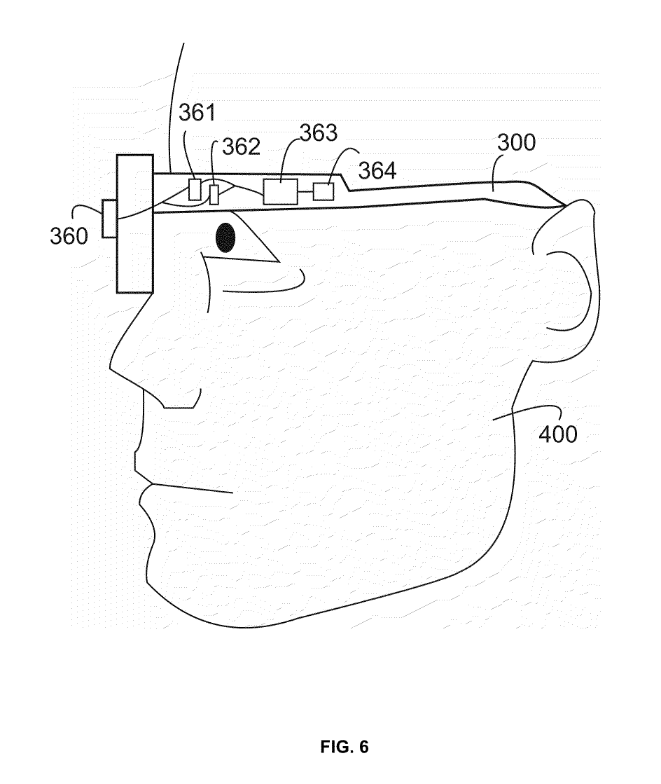

FIG. 5 shows an overhead view of the ability of the SPD 100 to project various patterns 301 onto a surface 302, which can be detected using the AR visor 300 or other imaging systems. The processing unit located in the visor 300, which is used for generating the augmented reality, produces an object 303 to be overlaid on the projected pattern 301. The projected pattern 301 is then masked by the virtual object 303 in two dimensions (2D) or 3 dimensions (3D). As the projected pattern 301 moves, the virtual 303 object also moves since it is locked to that specific pattern. In some embodiments the projected pattern or grid 301 may be created by infrared light. The infrared grid 301 can be reflected off the physical surface 302 and detected by the visor 300. In these embodiments the projected grid surface 301 may be or may not be visible to the user but is always detected by the visor's image processor 363 and the visor's camera 360 which are shown in FIG. 6. The SPD 100 can generate and project visible or infrared surface properties that can be seen and interfaced through an AR visor 300.

The projected patterns 301 can be recognized by means of an appropriate camera 360 present on the visor 300. As shown in FIG. 6, the imaging system of the visor 300 consists of imaging sensors for visible light 361 and/or infrared light 362, an image processor 363 and other processors 364. The processors 363-364 and sensors 361-362 analyze the visual inputs from a camera 360 or any other video source. The camera 360 is able to send pattern recognition signals to the central processing unit also located in the visor. Virtual 3D objects 303 can then be created using the AR visor's 300 graphics processing engine to be used in conjunction with the position-based guidelines set out by the projection device. The VR objects 303 and surface pattern 301 can be locked to the surface so as when the camera 360 of the visor 300 pans around the physical surface the augmented images will be fixed to that physical pattern. Through the AR visor 300 imaging system, a user can virtually manipulate projected cities, countries, buildings and other objects augmented onto the surface.

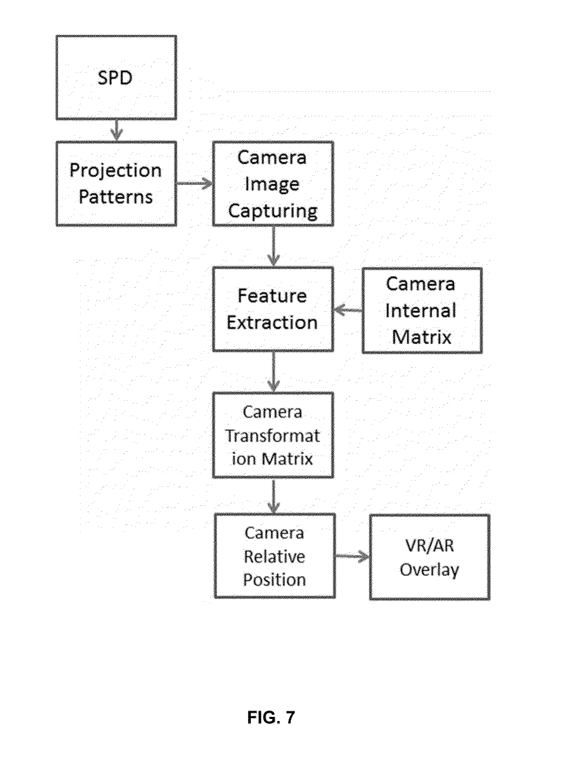

FIG. 7 shows a diagram of how the SPD and the visor work together to create virtual objects that are located on specific coordinates on the projected pattern. The SPD projects the predefined patterns on the surface. The image capturing system of the visor captures the patterns and extracts the feature points in the predefined patterns. According to the image capturing device or internal parameters, the camera's 3D transformation matrix is calculated based on feature points matching. The camera's relative position and orientation to the surface is estimated and is used for VR/AR content overlaying.

The SPD 100 is used to provide gesture recognition or interference recognition by implementing an algorithm in its processor 101. This algorithm allows users or objects to interact physically with the surface. The algorithm works by detecting the exact position of the gesture(s) through the projection device's onboard camera 106 and imaging system, and relays such events to the master processor 101, AR visor(s) 300 or other systems. The ability to manipulate projected virtual objects 303 may entail users having to make strategic movements of components in a virtual city or virtual building blocks tied to the other teammate, or the opponents may be linked to control points in more complex parametric gaming maps.

An obstacle detection laser source or ultrasonic source 102 is incorporated into the design to determine the position of interaction with the surface. This embodiment of the SPD 100 is designed for use in an AR system. The obstacle laser or ultrasonic source 102 detects real surfaces and objects and creates the projected surface 301 to suit the detected physical surface 302 and objects. When a user 400 touches the surface within the area of the projected surface pattern 301, the SPD 100 detects the position of the touch on the surface pattern 301 and relays the coordinates back to the SPD system.

Alternative embodiments contain a holographic optical element or diffractive optics that generates the surface light image required for surface interaction within the projected pattern 301. The optical element creates microscopic patterns that transform the origin point of the light emitting source into precise 2D or 3D images overlaid or augmented on the projected surface 301. The SPD 100 has the adaptability to accommodate several surface interactive software developments due to its ability to dynamically map surfaces. The 3-axis compass 104 can also determine the orientation of the SPD 100 when it is projecting the pattern on the surface.

The projected pattern 301 also allows for the user(s)' 400 touch and movement to be detected and to be used as methods for input. Following the user(s)' 400 touch or with gestures on the visible or infrared projected light sources, the system can determine the position of the area of the user 400 engaged interaction on the projected grid 301 system. The SPD's 100 laser or other light source 202 projects light though a holographic image emitter to produce an image that is required for the particular application of the user(s)' game or simulation.

The AR visor 300 is able to create a dynamic and adaptable augmented reality where virtual objects naturally respond to the physics and movement of gestures and touches. Three-dimensional (3D) or two-dimensional (2D) objects 303 are placed on the projected surface 301 that can then be mapped to certain patterns on the grid. The projected pattern 301 is able to move and, because the virtual object 303 is locked to the pattern 301, the virtual object 303 can move along with the pattern 301. The AR visor 300 is able to track the virtual objects 303 associated with the projected pattern 301. As the user(s) 400 interact with the virtual object(s) 303 with hand gestures, the virtual object 303 and pattern 301 respond to the gesture. Any physical objects on the projected surface can be tracked with the AR visor 300 or SPD 100. The SPD 100 is able to apply the pattern to the projected light source onto a surface in which it is represented by augmented images.

The coordinate systems need to be referenced so that the interactive software or interaction with the AR visor(s) 300 can be set. The SPD 100 performs the reference using a wireless communication device 104 that is attached to the AR visor 300 or by using a server where it can be polled for interference detection in relation to the touch system on the surface from the user(s)' position.

The coordinate system is also used to ensure that the appropriate orientation and display of the virtual objects 303 and projected pattern 302 are displayed to multiple AR visors 300 when used in a multi user setting. The Wi-Fi communication ability of the AR visor 300 and the SPD 100 allows for tracking the position of each AR visor 300 and make it known to other AR visors and the SPD 100.

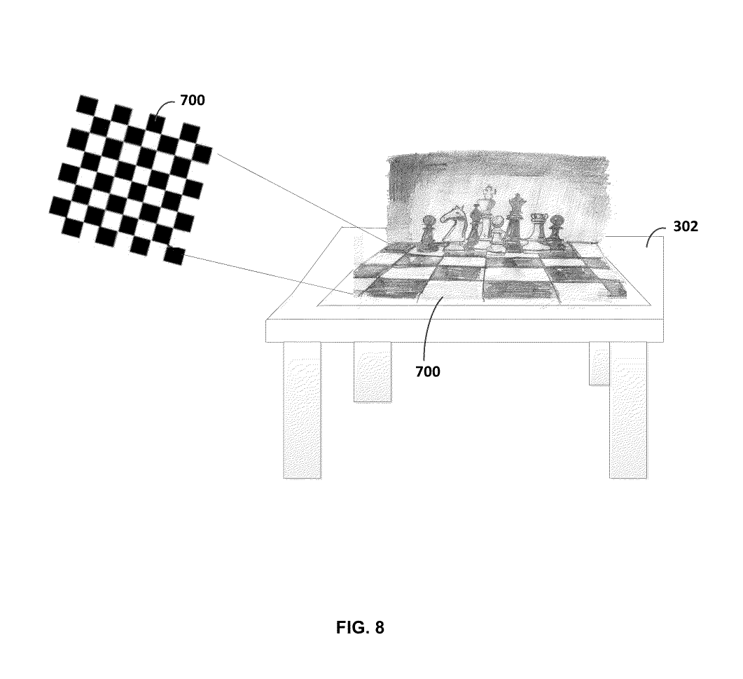

FIG. 8 shows one embodiment of the present invention for playing an augmented reality chess game. Infrared light images from the SPD 100 create the board 700 of the chess game on the surface of a table 302. The AR visor(s) then sees this infrared grid and augments or overlays computer generated graphics, characters or objects 303 by using the chessboard grid created by the light particles as the boundaries or game surface properties. The AR visor(s) 300 uses the projected blueprint on the surface as the input parameters to define the game size, behaviour, or other properties. The SPD 100 with the use of a camera 360 and an illumination module can determine the interaction from external media such as hand movements on the surface.

Other embodiments allow for features such as animated 3D and 2D images and objects to be displayed with this system as well having the ability to display and animate text.

What is claimed is:

1. An Augmented Reality (AR) system for generating a projection pattern on a surface comprising:
a. a projector comprising:
i. a light source;
ii. a set of lenses;
iii. means to capture imaging data from said surface;
iv. a processor to generate a computer generated image (CGI) or a pattern to be projected on said surface;
v. a 3-axis compass to determine the orientation of said projector; and
vi. a Wi-Fi communicator;
b. an AR visor comprising:
i. at least one camera to scan and view said surface in 3D;
ii. means to determine direction, orientation and movement of said AR visor relative to said surface;
iii. a battery management and supply unit to provide power to said AR visor;
iv. a Wi-Fi communicator providing communication between said AR visor and said projector;
v. a processor unit to process collected data from said camera and said means to determine direction, orientation and movement by said AR visor and to create plurality of CGI objects on said generated pattern; and
vi. a display means to display said projection pattern and plurality of CGI objects;
c. wherein said processor in said AR visor having the ability to recognize hand and finger movements on said projected pattern for interaction with said projected pattern and said projected objects;
whereby combination of said means to capture imaging data from said surface and said 3-axis compass being used to recognize the surface conditions, and said projector projecting said pattern on said surface, which is detected by said AR visor.

2. The augmented reality system of claim 1, wherein said projector projects a chessboard pattern on said surface, wherein said projected chessboard pattern being comprised of alternating black and white squares in an 8 by 8 matrix, wherein said projected objects being chess pieces generated by said processor on said AR visor, wherein said user interacts by hand to virtually move said projected objects on said projected pattern.

3. The augmented reality system of claim 1, wherein said projector further projecting a grid onto said surface, said grid being used to determine the location and the orientation of said objects on said surface wherein said grid being detected by said AR visor.

4. The augmented reality system of claim 1, wherein said means to capture imaging data being selected from the group consisting of a camera, a distance sensor, an orientation sensor, an ultrasound sensor, a laser range finder and a gyroscope.

5. The augmented reality system of claim 1, wherein said processor in said projector having capability to move, orient and reposition said projected pattern.

6. The augmented reality system of claim 1, wherein said projector being able to generate a visible or an invisible projected pattern.

7. The augmented reality system of claim 6, wherein said invisible pattern being an infrared pattern.

8. The augmented reality system of claim 1, wherein said projector being a holographic projector to project a pattern onto a space.

9. The augmented reality system of claim 1, wherein said visor generated said objects being coupled with said projection pattern whereby said objects move with movement of said projection pattern.

10. The augmented reality system of claim 1, wherein said projector further having means to detect obstacles on said surface to determine the location and orientation of said obstacle on said projection pattern and to integrate said obstacle into said projection pattern.

11. The augmented reality system of claim 10, wherein means to detect obstacles on said surface being obstacle detection laser source or ultrasonic source.

12. The augmented reality system of claim 1, wherein said projector being able to dynamically map said surface, dynamically interact with said AR visor and dynamically alter said projection pattern.

13. The augmented reality system of claim 1, wherein said system being used by plurality of users wearing said AR visor(s) to interact with said objects and said projection pattern.

14. The augmented reality system of claim 1, wherein said projector further being used to project animated 3D or 2D CGI objects.
